(19) United States
(12) Patent Application Publication
(10) Pub. No.: US 2005/0161964 A1
(43) Pub. Date: Jul. 28, 2005

(54) Cargo bed extender

(76) Inventor: George Kenneth Adleman JR., Loma, CO (US)

Correspondence Address: EDWIN L. HARTZ, 2537 FALLS VIEW CIRCLE, GRAND JUNCTION, CO, 81505, US

(21) Appl. No.: 10/764,639

(22) Filed: Jan. 26, 2004

(51) Int. Cl. B62D 33/02

(52) U.S. Cl. 296/26.09

(57) ABSTRACT

A cargo bed extender has two attached members that lay on a cargo area in parallel relation and are aligned from front to back, two movable members that telescope inside the attached members and a cross member at the end of each movable member remote from the attached members. The movable members are held in a selected telescoped position by securing means.

### BACKGROUND OF THE INVENTION

1). Field of Invention

This invention relates to increasing the carrying capacity of a cargo bed beyond the bed area and more particularly to a telescoping extender that takes the load off the tailgate and places it on the extender over and/or beyond the tailgate.

2). Related Art

Cargo beds of cargo transports such as pickup trucks, flatbed trucks and trailers have a defined area. This area is usually defined by two side walls, a front wall and a tailgate. The tailgate opens to provide space beyond the end of the cargo bed for cargo that is longer than the front to rear distance of the cargo bed. Cargo, including but not limited to, rolls of carpet, lumber, and four-wheel recreational vehicles often extend beyond the end of the cargo bed. Usually such cargo lays on and burdens the tailgate, often damaging the tailgate by bending the tailgate or by breaking the means for holding the tailgate.

A relatively elaborate truck bed extender, which addresses this problem, is disclosed in U.S. Pat. No. 5,823,597, granted to Thomas Anderson on Oct. 20, 1998. This patent discloses a receiver mounted at the front end of the truck bed with a pair of trusses removably connected to the receiver. This device requires a front wall for attachment and numerous pieces to form the trusses. Further, the load carried in the back of the truck is supported by the top surface of the trusses and cross members between the trusses. Additionally the trusses have a fixed length and are not adjustable in length to accommodate different bed lengths or load lengths.

An extendable cargo deck for pickup trucks, having a rearwardly opening cargo bed bounded by side walls, having inwardly projecting rails spaced above the floor of the cargo bed is the subject of U.S. Pat. No. 6,491,331 to Daniel B. Fox, issued Dec. 10, 2002 and U.S. Patent Application with publication # U.S. 2002/0180231 published on Dec. 5, 2002. The disclosed extendable cargo deck requires that the truck have side walls with inwardly projecting rails for mounting the cargo deck. Consequently, the cargo deck is limited to one particular type of truck.

Another approach for extending a cargo area is disclosed in three U.S. Patents to Morse et al. These Patents are U.S. Pat. Nos. 6,283,525; 6,394,524 and 6,598,922. The extenders of these Patents are located above the truck bed and are supported by the side walls of the truck bed.

A further approach to extending the cargo area of a truck bed is disclosed in U.S. Pat. No. 5,451,088 to Robert L. Broad, which issued on Sep. 19, 1995. The extension of this Patent employs the box receiver hitch that is at the back of a truck and a two axis cantilevered T-shaped device that extends rearwardly and upwardly from the box receiver. All components of this extension for a pickup truck are beyond the cargo area of the truck.

There are many devices for use in truck beds and vehicle storage areas, in general, that are designed to provide easy access to the objects stored or carried in the storage area. These devices are not specifically for extending the load carrying capacity beyond the rear end of the cargo area, but rather for ease of access to the load in the cargo area. Representative of these devices are those disclosed in U.S. Pat. Nos. 6,312,034 and 6,464,274 to Mink et al; U.S. Pat. No. 6,503,036 to Bequette et al; and U.S. Pat. No. 6,390,525 and Patent Application with publication No. U.S. 2002/0005648 and publication date of Jan. 17, 2002 to Carpenter et. al.

### SUMMARY OF THE INVENTION

All of the devices disclosed in, or the subject of, the above referenced patents and applications, are relatively complex and costly.

The ability to increase the cargo area without loading the tailgate in a simple, versatile and economical way is desired. This is accomplished by attaching two members to the cargo bed with the members aligned in the front to rear direction of the cargo bed. A member telescopes from each attached member and a cross member is fixed to the end of each member that is remote from its respective attached member. The telescoped position of each movable member relative to its associated attached member is fixed by a pin penetrating a hole in each movable member. The movable member is held against the pin by a securing arm that goes over the movable member in the area of the pin. Alternatively, the pins are held in place by a spring-loaded lever that is biased down toward the movealbe member or by a pin that is pushed into its housing and against a spring that holds the pin away from the movable member. The fixing and securing means provide a safety latch, near the rear end of each attached member to hold the movable members in place.

The two attached members are size 2 inch Schedule 40 steel pipe and the two movable members and the cross member are size 1½ inch Schedule 40 steel pipe (ANSI Pipe Schedules). These members can be of different material and size and can also be square, rectangular, or some other configuration with a movable member of corresponding configuration positioned inside and able to telescope into and out of the attached member.

The attached members are secured to the cargo bed by welding the front end of each member to a plate that is bolted to the cargo bed at the front end of the attached member. Alternatively, the attached members can be hinged to a plate or directly to the cargo bed or removably attached through use of slots and bolts attached to the cargo bed. The rear end of each attached member is elevated above the cargo bed so that the cross member at the end of the movable members and the movable and attached members will carry the extended load rather than the tailgate of the cargo bed carrying the extended load. For heavy loads that exceed the carrying capacity of the attached and movable members and cross member, a two armed support is provided. The two arms have telescoping members, with the inner members extending from the receiver box for a hitch at the rear of the cargo bed. The telescoping members extend to the opposite ends of the cross member inside the attachment to the ends of the two movable members and are held in place by the connection between the two ends of the cross member and the respective ends of a movable member.

Objects, features and advantages of this invention will become apparent from a consideration of the forgoing and the following description, the appended claims and the accompanying drawings.

### BRIEF DESCRIPTION OF THE DRAWINGS

FIG. 1 is a perspective view of the cargo bed extender in a cargo bed from the left rear of the cargo transport, in accordance with the present invention;

FIG. 2 is a perspective view of the cargo bed extender in a cargo bed from the left rear of the cargo transport, with the tailgate down, in accordance with the present invention;

FIG. 3 is a perspective view of the cargo bed extender in a cargo bed from the left rear of the cargo transport, with the tailgate down and the cargo bed extender extended, in accordance with the present invention;

FIG. 4 is a perspective view of the cargo bed extender in a cargo bed from the left rear of the cargo transport, with the cargo bed extender extended and a floor in a portion of the extended cargo bed extender, in accordance with the present invention;

FIG. 5 is a perspective view of the cargo bed extender in a cargo bed from the left rear of the cargo transport, with the cargo bed extender extended and with side walls and floor to enclose the extended area, in accordance with the present invention;

FIG. 6 is a left side elevation view of the cargo bed extender with a heavy load support in place from the trailer hitch receiver to the end of the cargo bed extende,r in accordance with the present invention;

FIG. 7 is a top plan view of the cargo bed extender with the support for heavy loads in place, in accordance with the present invention;

FIG. 8 is an exploded view of the elements of the cargo bed extende,r in accordance with the present invention;

FIG. 9 is a left side elevation view of one of the attached members of the cargo bed extender, in accordance with the present invention;

FIG. 10 is a rear end elevation view of one of the attached members of the cargo bed extender, in accordance with the present invention;

FIG. 11 is a left side elevation view, partially cut away, of one of the movable members of the cargo bed extender, in accordance with the present invention;

FIG. 12 is a rear end view of one of the movable members of the cargo bed extender, in accordance with the present invention;

FIG. 13 is a bottom plan view of one of the movable members of the cargo bed extender, in accordance with the present invention;

FIG. 14 is a front elevation view of the cross member of the cargo bed extender, in accordance with the present invention;

FIG. 15 is a left end elevation view, partially cut away, of the cross member of the cargo bed extender connected to the end of the left side movable member, in accordance with the present invention;

FIG. 16 is a top plan view of one of the front mounting plates for an attached member of the cargo bed extender, in accordance with the present invention;

FIG. 17 is a top plan view of a fastener plate that fits under the truck bed in association with the mounting plate, in accordance with the present invention;

FIG. 18 is a top plan view of an elevating block that elevates the rear end of the attached member and includes a locking pin, in accordance with the present invention;

FIG. 19 is a cross-sectional view of the elevating block taken along the section lines 19-19 of FIG. 18;

FIG. 20 is a top plan view of the left side of the cargo extender at the locking point with the members in locked position, in accordance with the present invention;

FIG. 21 is a top plan view of the left side of the cargo extender at the locking point of the attached and movable member with the security lock in the unlocked position, in accordance with the present invention;

FIG. 22 is a left side elevation view, partially cut away, of the left side members at the locking point to show the pin and corresponding hole in the movable member, in accordance with the present invention;

FIG. 23 is a rear end elevation view, partially cut away, of the left side members at the locking point showing the attached member and movable member locked together, in accordance with the present invention;

FIG. 24 is an exploded view of the side walls and front panel and tailgate of the housing that encloses the extended portion of the cargo bed extender, in accordance with the present invention;

FIG. 25 is a top plan view of the floor panel that provides a floor in the extended area of the cargo bed extende,r in accordance with the present invention;

FIG. 26 is a left side elevation view of the floor panel, in accordance with the present invention;

FIG. 27 is a rear elevation view of the floor panel, in accordance with the present invention;

FIG. 28 is a top plan view of the telescoping support arms for heavy loads that extend from the receiver hitch, in accordance with the present invention;

FIG. 29 is a front elevation view of the telescoping support arms showing the square coupler that fits in the receiver hitch, in accordance with the present invention;

FIG. 30 is a right side elevation view of the telescoping support arms for heavy loads, in accordance with the present invention;

FIG. 31 is a top plan view of an alternative locking device for securing the movable member relative to the attached member, in accordance with the present invention;

FIG. 32 is a left side elevation view, partially cut away, of the alternative locking device, in accordance with the present invention;

FIG. 33 is a rear end elevation view, partially cut away, of the alternative locking device, in accordance with the present invention; and

FIG. 34 is a left side elevation view, partially cut away, of the alternative locking device with the locking device released and showing the locking device in locked position in phantom lines, in accordance with the present invention.

### DESCRIPTION OF PREFERRED EMBODIMENTS

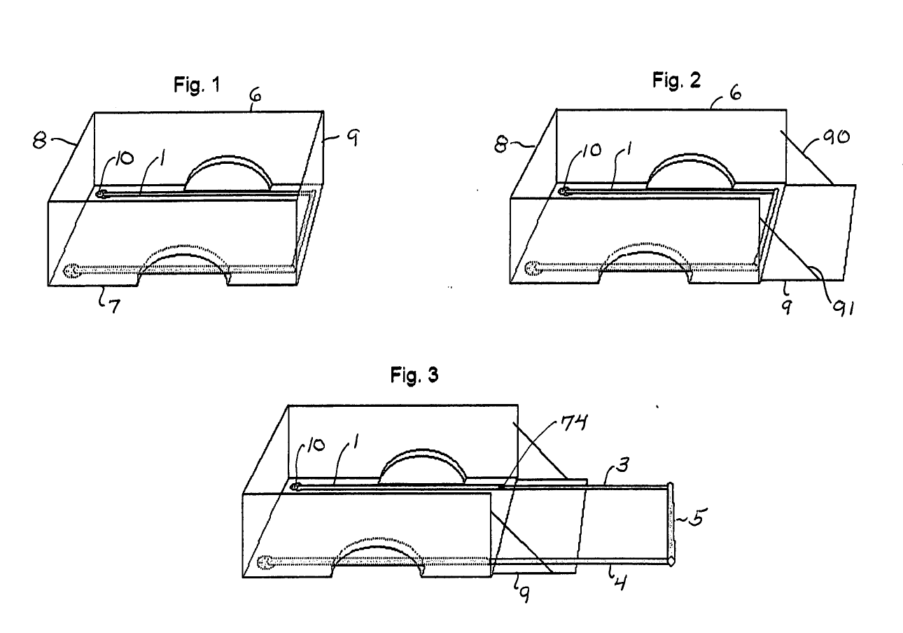

A simple, versatile and economical cargo bed extender is shown in use in FIGS. 1-7. This extender has five main members with a means for attaching two of the five members to the cargo bed and a means for securing two of the members in a selected position relative to the attached members. The five main members are a first attached member 1, a second attached member 2, a first movable member 3, a second movable member 4, and a cross member 5 attached to the remote or rear ends of the movable members 3 and 4.

The cargo bed extender is useful in any cargo transport that has a cargo area and an opening at the rear end. In particular the cargo bed is useful in a pickup truck, with or without at tailgate, flatbed trucks and trailers, with or without a tailgate. The cargo area is defined as the flatbed area that is typically enclosed by two side panels, a front panel and a tailgate as show in FIGS. 1-5. On a flatbed truck and similar cargo transports it is the flat surface area of the truck bed.

A problem exists in carrying cargo that extends beyond the rear end of the cargo area. Typically the tailgate is placed in a horizontal position and held by some hanging means such as chains 90 and 91. Often times the cargo that extends beyond the rear end of the cargo area is heavy and damages the tailgate or breaks the means for supporting the tailgate. The cargo area of the various cargo transports vary in size, for example in pickup trucks, the flat cargo area between the wheel wells is typically 4 foot by 8 foot. However some of the pickup trucks have a short bed that is 5 foot long rather than 8 foot. Additionally there are now truck beds that are 6 feet 4 inches long, which happens to be the length of a 4-wheel off road vehicle.

One type of cargo that is often in a pickup is carpet, which is 12 feet wide. With such width, at least 4 feet extend beyond the rear end of the cargo area. In some cases, the extension beyond the rear end is greater because a tool box occupies the front of the cargo area. The weight of the cargo beyond the cargo area can be great. For example, many times there are a plurality of rolls of carpeting and padding in the cargo area of a pickup truck and as a consequence there is a heavy load placed on the tailgate and the tailgate supporting means. Another cargo that often times extends beyond the rear end of the cargo area is lumber. Many pieces of lumber have a 10, 12, 14 or 16 foot length. It is not uncommon to have 8 feet of lumber extending beyond the rear end of the cargo area.

The cargo area extender is designed to relieve the load or remove the load from the tailgate and carry it on the extender. A typical size for the cargo extender is attached members 1 and 2 having a length of about 7 feet 3 inches in an 8 foot pickup bed and the movable members extending up to 4 feet beyond the rear end of the cargo area without heavy load support. In this way, a roll of 12 foot wide carpet will extend only 4 feet beyond the rear end of the cargo bed, and the load beyond the end of the cargo area is carried by the extender, rather than being placed on the tailgate. The movable members, having a length of 7 feet, can extend more than 4 feet beyond the end of the cargo area for light loads. For most uses, the movable members have the last locking hole at a position to provide 4 feet of extension beyond the rear end of the cargo area.

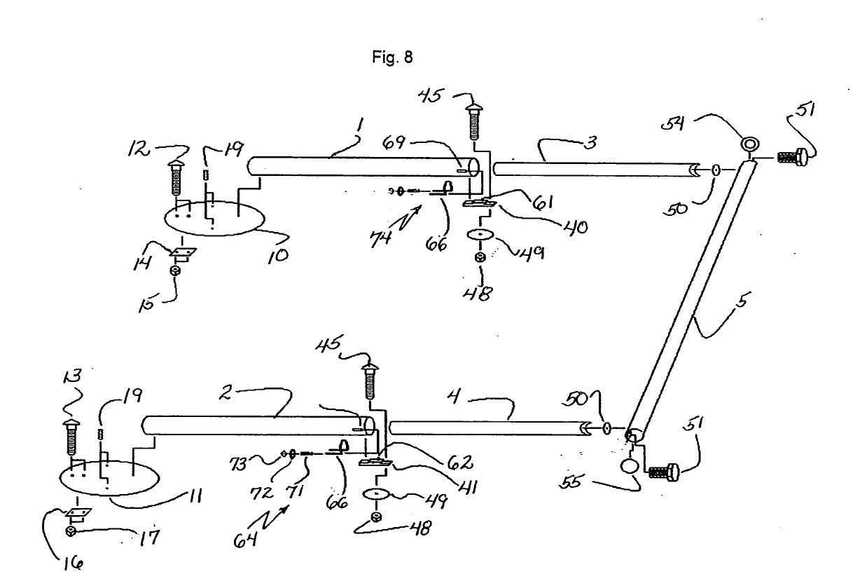

Referring to the drawings, in FIGS. 1-7, the front end of the cargo area is to the left so that the views of FIGS. 1-5 are from the left rear perspective. With reference to the exploded view of FIG. 8, it is seen that the cargo bed extender has a first attached member 1 and a second attached member 2, a first movable member 3 and a second movable member 4 and a cross member 5. The first attached member 1 and the second attached member 2 are size 2 Schedule 40 steel pipe and have an internal diameter of approximately 2 1/16 inches. The movable members 3 and 4 slide inside the respective attached members 1 and 2 and can telescope into and out of the attached members 1 and 2. The movable members are size 1½ Schedule 40 steel pipe with an outside diameter of 1.9 inches. This results in a clearance between the movable pipe and the attached pipe of approximately ¼ inches, which permits easy sliding of the movable pipe into and out of its associated attached pipe 1 or 2. Other materials, such as stainless steel or heavy plastic, for example, may be used in place of steel pipe. Any substitute material, of course, must have sufficient strength to carry the load of the cargo carried.

A size 1½ Schedule 40 steel pipe, as the cross member 5, is attached to the ends of the movable pipes 3 and 4 that are remote from the attached pipes 1 and 2. When used in a pickup bed, the cross member has a length of 4 feet and the attached members 1 and 2 lay parallel inside and against the wheel wells. The length of the cross member 5 can be adjusted to accommodate the various cargo area sizes. Some pickups have a different distance between wheel wells, than 4 feet.

A right hand mounting plate 10 and a left hand mounting plate 11 are attached to the cargo bed by a pair of bolts 12 and a pair of bolts 13 respectively (only one bolt of the pair being shown). Bolts 12 pass through the mounting plate 10, the cargo bed of the cargo transport and a washer 14 before being locked into place by a pair of nuts 15 (only one being shown). Similarly, mounting plate 11 is attached to the cargo bed by a pair of bolts 13 passing through the mounting plate 11 and the cargo bed into a washer 16 and finally a pair of nuts 17. The attached member 1 is welded to the mounting plate 10 and the attached member 2 is welded to its mounting plate 11. However, the attachment may be made in other ways such as by bolts or by a U-bolt attached to the cargo bed and holes in the attached members 1 and 2 to provide a hinged connection between the attached members and their mounting plates. Each of the mounting plates 10 and 11 have a pair of set screws 18 and 19 that provide for leveling of each mounting plate relative to the cargo bed. Some cargo areas, such as pickup truck beds, have bed liners and in this case the bolts 12 and 13 will also pass through the bed liners so that the mounting plates are securely attached to the cargo bed of the cargo transport.

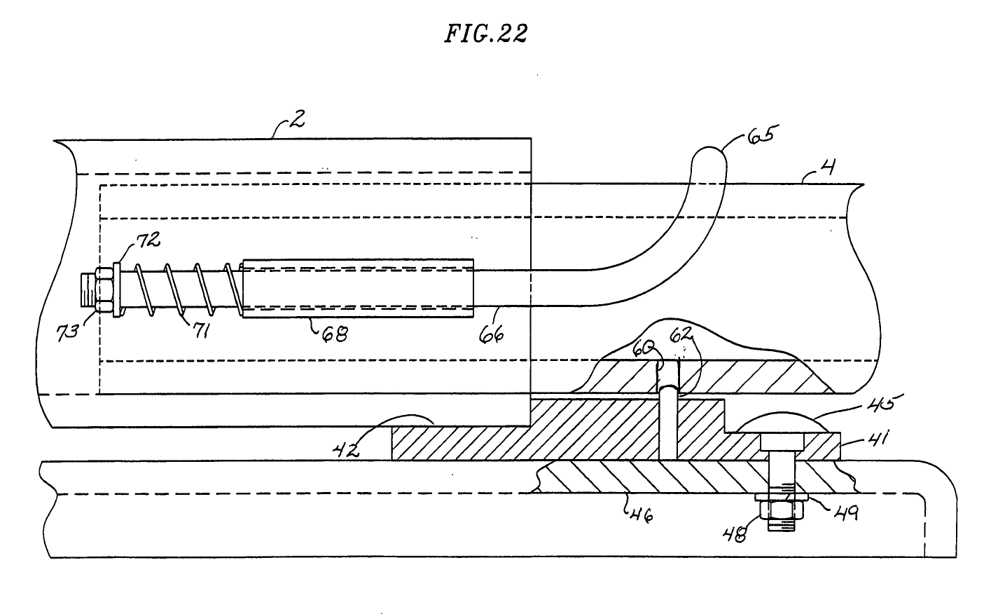

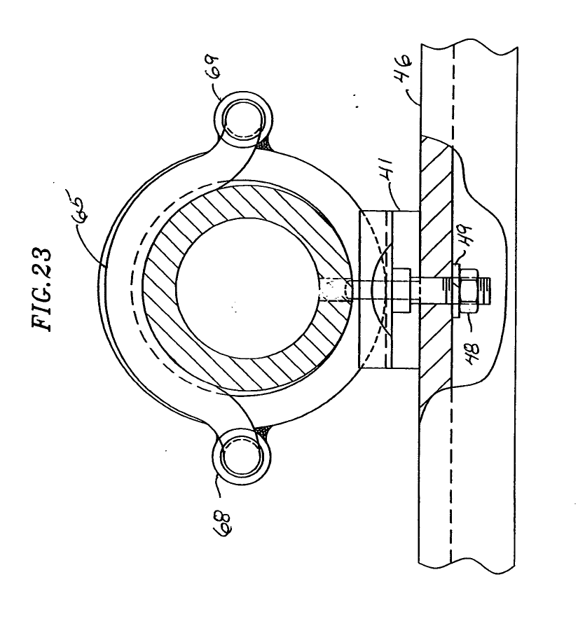

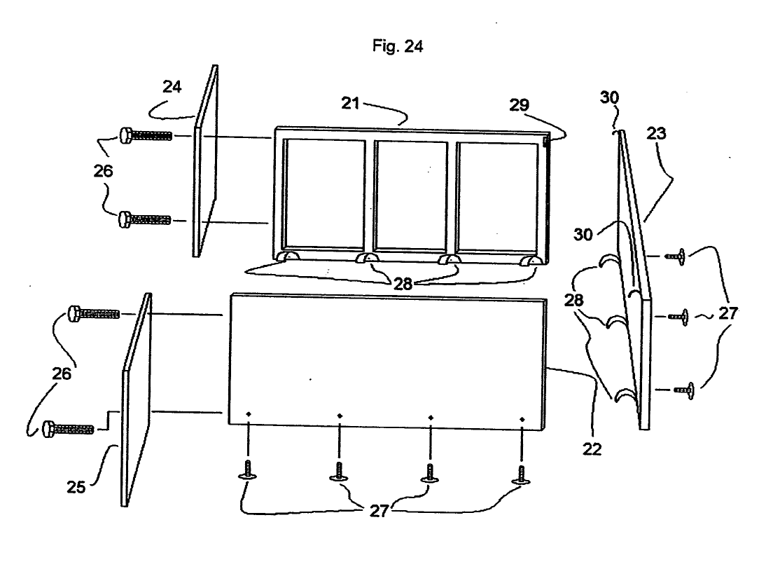

The attached members 1 and 2 are parallel and are aligned with the cargo area from the front to the rear of the cargo area. Near the rear of the cargo area, each attached member 1 and 2 is elevated by a block 40 and 41, respectively. The configuration of block 40 is identical to block 41, and block 41 is shown in greater detail in FIGS. 18 and 19. Block 41 has a step 42 at the front end and a second step 43 at the rear end. The rear end of the attached member 1 rests on the surface of the step 42 and is thus elevated above the cargo bed by the height of the step 42 (See FIG. 22). This height is selected so that the load resting on the cross member 5 does not touch the tailgate 9 of the cargo transport. A ¼ inch elevation for the step 42 has been found to be satisfactory for most loads. A bolt hole 44 is provided in step 43 for attaching the block 41 to the cargo bed of the cargo transport. The positioning of the attached member 2 relative to the elevating block 41 is shown in FIG. 22. It is seen in FIG. 22 that the rear end of attached member 2 rests on the surface 42 of block 41. Additionally, in FIG. 22 it is seen that a bolt 45 passes through the hole 44 and also through the cargo bed 46 to be fastened in place by a washer 49 and a nut 48 under the cargo bed 46. In this way the block 41 is securely fastened to the cargo bed 46. Advantageously, the underside of the head 45 has a square configuration that fits in a square hole 47 in the elevating block 41 to hold the bolt 45 while the nut 48 is being tightened. Block 40 elevates attached member 1 and is attached to the cargo bed in the same way block 41 elevates and is attached. Usually, the front end of each attached member is within one foot of the front of the cargo area and the rear end is within one foot of the rear of the cargo area.

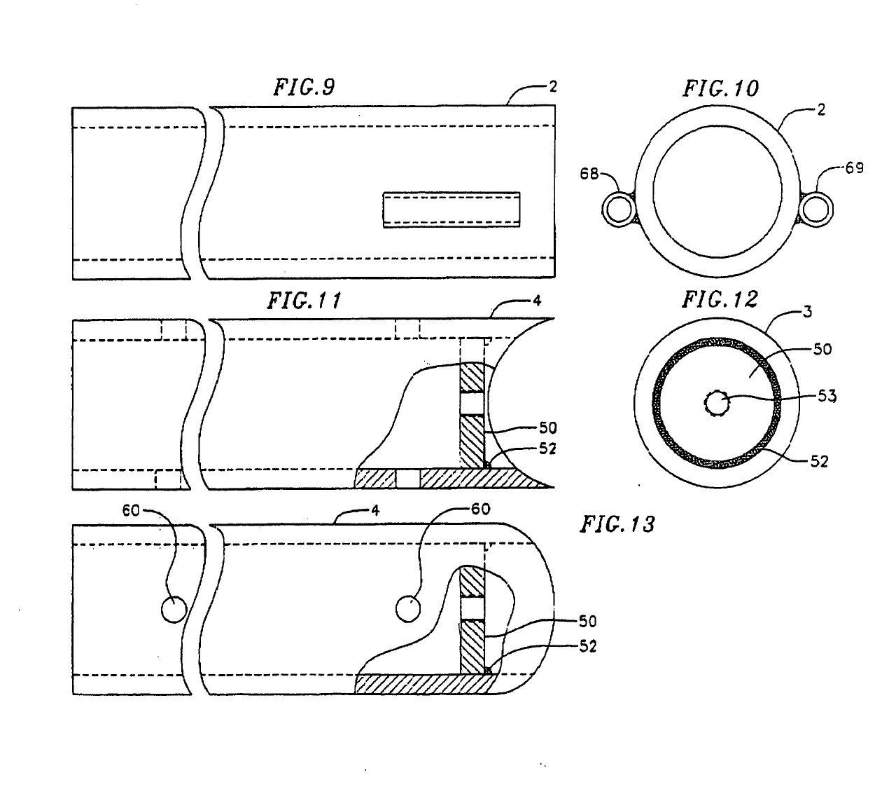

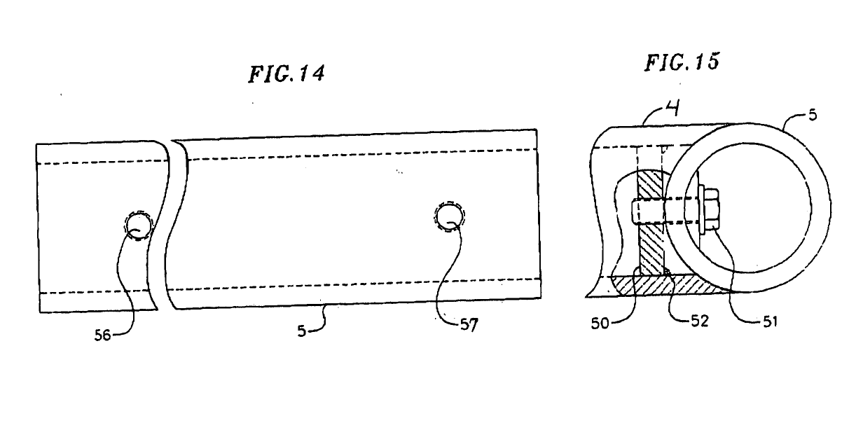

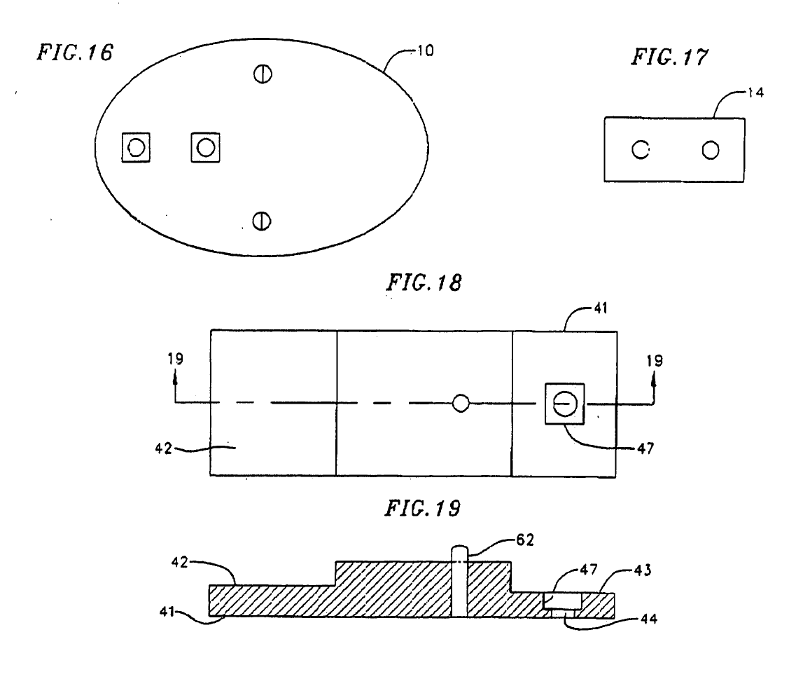

The rear end or the end remote from the attached members 1 and 2 of each of the movable members 3 and 4 is cut to accommodate the cross member 5 as shown in FIGS. 11-15. This cut provides a semi-circular surface that abuts the outside curved surface of cross member 5. Cross member 5 (FIG. 14) has a hole 56 at one end (the right end) and a hole 57 (the left end) to accommodate mounting bolts (one of which is shown in FIG. 15.). The left side movable member 4 is shown in FIGS. 11-13. The description, with respect to the left side movable member 4, also applies to the right side movable member 3. A nut 50, that has a circular diameter that is slightly smaller than the inside diameter of the movable pipe 4, is positioned inside and near the end of pipe 4. The nut 50 is placed near the end of the movable member 4 to accept a short bolt 51 in cross member 5, shown in FIGS. 8 and 15. The nut 50 is attached inside the movable member 4 by a weld 52, around the nut 50, as shown in FIGS. 11, 12 and 13. The nut 50 has a threaded center hole 53 which mates with the threads of the bolt 51. End caps 54 and 55 (FIG. 8) are placed over the ends of the cross member 5 after the cross member 5 has been attached to the ends of the movable members 3 and 4.

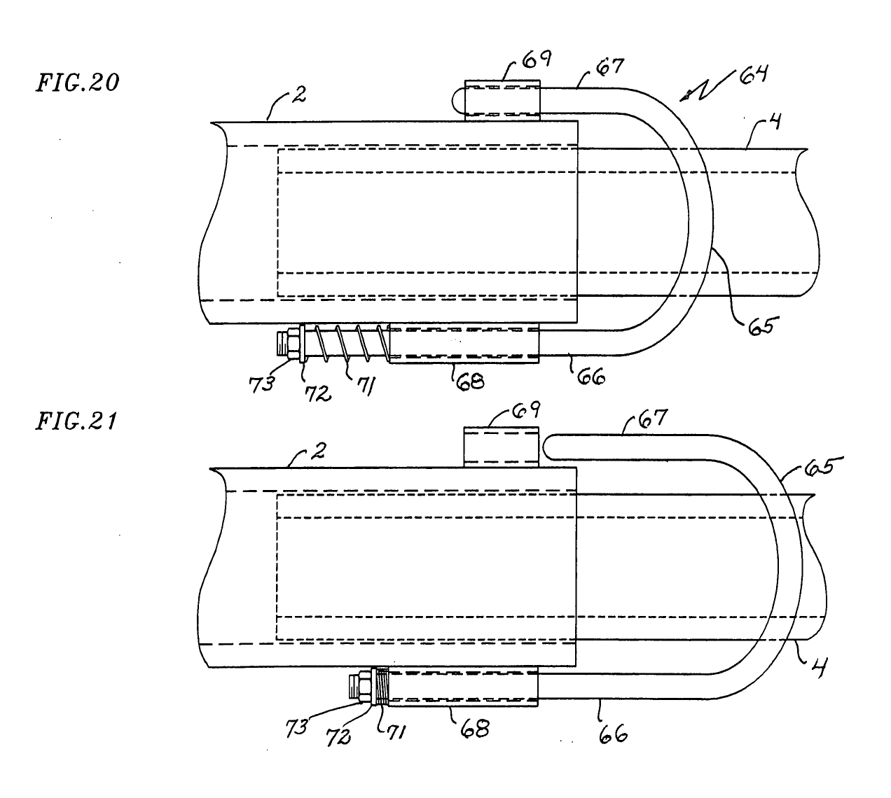

The movable members 3 and 4 telescope inside their respective attached members 1 and 2 to accommodate different lengths of load on the cargo bed extender. Once the selected distance of the cross member 5 beyond the rear end of the cargo area is reached, the movable members 3 and 4 are locked into position. There are a series of holes in the bottom of the movable members 3 and 4 as show in FIG. 13. These holes 60 are advantageously spaced 16 inches apart to provide selected distances at which the movable members may be fixed relative to the attached members 1 and 2. The hole nearest the front end of each movable member is at a distance from the rear end of the member to provide an extension of 4 feet beyond the rear end of the cargo bed. The spacing may be different for selected applications. Cooperating with the holes 60 is a pin 61 that is carried by the block 40. Similarly, a pin 62 is carried on the left side of the cargo bed extender by block 41. The approximate ¼ inch play between the inner surface of attached member 1 or 2 and the outer surface of movable member 3 or 4, permits the movable members 3 and 4 to be lifted above the pins 61 and 62. This provides sufficient clearance so that the movable members 3 and 4 may be slid into and out of their respective attached members 1 and 2. When the selected position is reached, the movable members 3 and 4 are dropped down on the pins 61 and 62 and a corresponding hole 60 will accommodate each of the pins 61 and 62 as shown in FIG. 22. This fixes the position of the movable members 3 and 4 relative to their attached members 1 and 2. However, as the cargo transport moves down the highway or across the terrain there is the possibility of the movable members 3 and 4 bouncing up and out of their position so that the pins 61 and 62 are no longer in a corresponding hole 60. To prevent the accidental disengagement of the movable members 3 and 4 from the pins 61 and 62, a locking device is provided as shown in FIGS. 20-23.

The locking device 64, in cooperation with the fixing device of pin 61 and hole 60 provides a safety latch for the cargo bed extender. The locking device 64 has a U-shaped portion 65 and two legs 66 and 67. Leg 66 is mounted to the attached member 2 by a mounting block 68. Leg 67 is a shorter leg than leg 66 and is the locking leg and fits into a locking block 69 on the right side of the attached member 2. The mounting block 68 and locking block 69 are shown in FIGS. 22 and 23 positioned about halfway between the top of attached member 2 and the bottom of attached member 2. However, in FIG. 10 the blocks 68 and 69 are shown below the mid-point between the top and bottom of the attached member 2. When positioned as shown in FIG. 10 below the mid-point between the top and bottom of the attached member 2, more pressure can be put on the movable member 4 when the locking device is in place. Nevertheless, the explanation of the operation of the locking device will be with respect to FIGS. 20-24 where the mounting blocks are at mid point and knowing they can be located elsewhere such as below the mid point (FIG. 10). The locking device 64 further includes a spring 71 that is on the leg 66 at the front of the mounting block 68. A washer 72 and a nut 73 are beyond the spring 71 for holding the spring in place on the leg 66 in front of the mounting block 68.

The locking device is shown in locked position in FIGS. 20, 22 and 23. In the locked position the U-shaped portion 65 presses down on the movable member 4 and holds the movable member 4 against the pin 62 to hold the movable member 4 in place relative to the attached member 2. A similar action takes place on the right side of the cargo bed extender, except on the right side the spring 71, washer 72 and nut 73 and the mounting block 68 are on the outside or right side of attached member 1. In this way the spring 71 of the locking devices are on the outside of the cargo bed extender and do not interfere with the cargo that is placed inside the extender and resting on the crossbar 5. To move the movable member 4 the U-shaped portion 65 of the locking device 64 is pulled to the rear, as shown in FIG. 21, so that leg 67 clears the locking block 69 and the U-shaped portion 65 and leg 67 may be rotated about the leg 66 to the left and out of the way. Then the movable member 4 may be telescoped inside the attached member 2. Similar action takes place with the locking device on the right side for attached member 1 and movable member 4. This safety latch may be operated by one person with both the right side and left side being placed in the unlocked position with the U-shaped portion 65 being rotated out of the way so that by grasping the cross member 5 the movable members 3 and 4 may be telescoped into or out of the attached members 1 and 2.

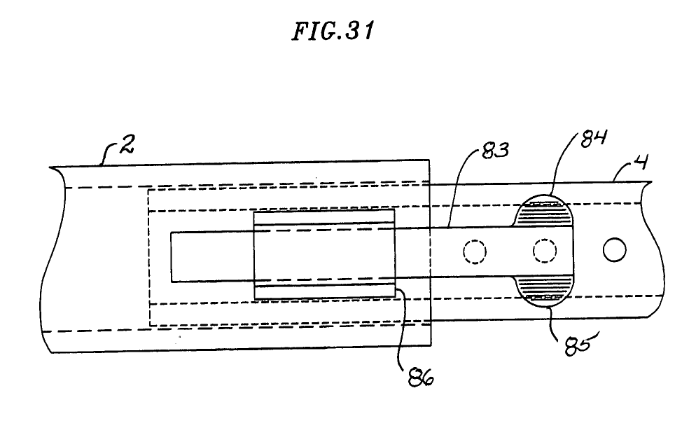

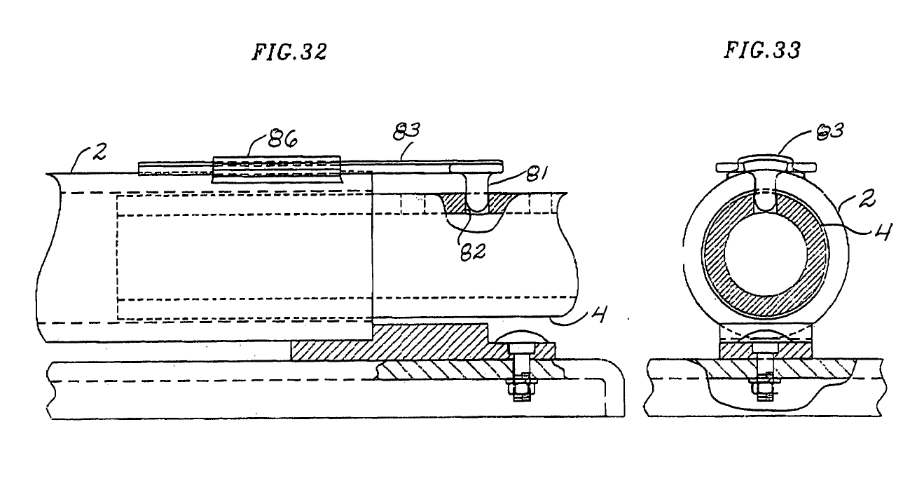

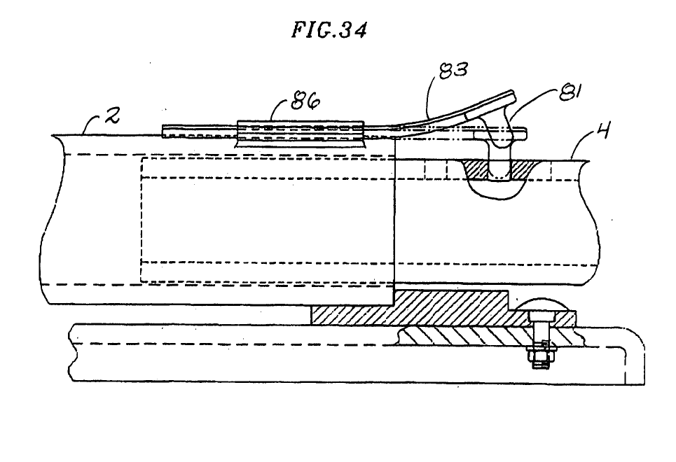

An alternative safety latch or locking device is shown in FIGS. 31-34. This locking device also includes a pin 81 that engages a hole 82 on the top of the movable member 4. The pin and holes may also be on the side of the attached and movable members. The pin 81 is attached to an arm 83 that is spring loaded and biased downard so that the pin 81 is held in the hole 82. Wings 84 and 85 are attached to the spring loaded arm 83 above the pin 81 and may be grasped to pull the pin 81 out of the hole 82. Once the pin 81 is pulled out of the hole 82, a wedge (not shown) is placed under the arm 83 on top of the movable member 4 to hold the pin 81 out of the hole 82 so that the movable member 4 may be adjusted relative to the fixed member 2. The same arrangement appears on the right side of the cargo bed extender at the end of attached member 1 for adjustment of the movable member 3 and for securing the movable member 3 in place. A mounting block 86 is attached to the attached member 2 for holding the spring loaded arm 83 for relative up and down movement with respect to movable member 4.

A heavy load support is shown in FIGS. 28-30 and is shown in use in FIGS. 6 and 7. This heavy load support is used when the load to be carried by the cargo bed extender exceeds the carrying capacity of the members of the cargo bed extender. For example, the cargo bed extender described above can carry loads up to 400 lbs when fully extended to 4 feet beyond the rear end of the cargo bed. The carrying capacity is greater for shorter extensions of the movable members 3 and 4 beyond the cargo bed. However, where heavy loads are to be carried, the heavy load support will be used. The heavy load support is designed to fit in the receiver hitch at the rear end of the cargo transport, such as a pickup truck. The heavy load support includes a square steel coupler 33 that fits in the square receiver hitch of the cargo transport. Attached to the square coupler 33 are two legs 34 and 35 that may be spread apart as needed to fit between the receiver hitch and the cross member 5 of the cargo bed extender. The support further includes legs 36 and 37 that telescope in the legs 34 and 35 to adjust for various lengths of cargo bed extenders. Legs 34 and 35 are pivotally mounted to the coupler 33 at points 38 and 39. Leg 34 is attached to coupler 33 by a bracket 76 and a pin 77. Similarly, leg 35 is connected to coupler 33 by a bracket 78 and pin 77. Brackets 76 and 78 provide pivot pins (not shown) at pivot points 38 and 39, respectively. Legs 36 and 37 are held in the selected position by set screws 79 and 80 that engage legs 34 and 35, respectively. Legs 36 and 37 are cut at the remote end to form a semi-circular surface 75 that accommodates the outside circular surface of cross member 5. Each leg 36 and 37 engage the cross member at opposite ends inside the connection to the movable members 3 and 4. Since cross member 5 is attached to movable members 3 and 4, the movable members 3 and 4 will hold the legs 36 and 37 in place out against the movable members 3 and 4 at the cross member 5.

To load the cargo bed of the cargo transport with the cargo bed extender in place and extended, a ramp may be placed between the cross member 5 and the ground for wheeled carriers or for 4-wheel vehicles, for example.

The five piece (member) cargo extender is elegant in its simplicity. It is much simpler and less expensive than those disclosed in the prior art patents discussed above. Additionally, it is very easy to install.

The size of the members is based upon the size of the cargo area and the dimension and weight of the cargo to be carried. For example., a 4-wheel off road vehicle may be carried in a short bed pickup with room for camping gear in front of the vehicle by using the cargo bed extender.

Additionally, two 4-wheel vehicles, each having a length of 6 feet 4 inches, can be carried, one behind the other, in an 8 foot pickup bed when using the cargo bed extender.

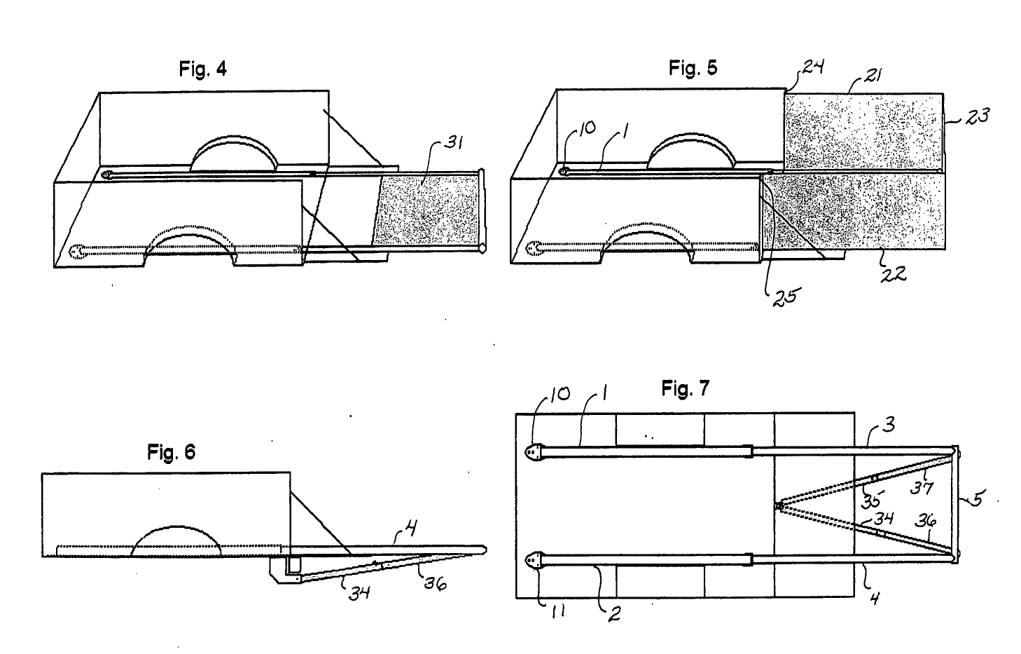

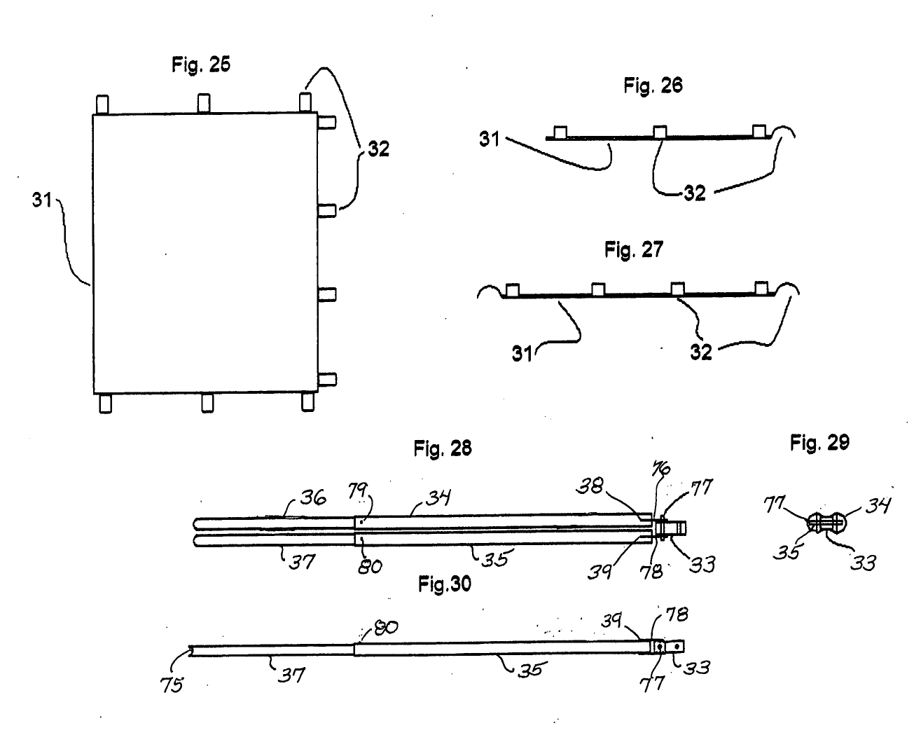

When cargo is to be carried beyond the rear end of the cargo area by the bed extended, a floor 31 is provided between the movable members 3 and 4 and the cross member 5 as shown in FIGS. 4, 25, 26 and 27. The floor 31 has curved hooks 32 that fit over the pipes of movable members 3 and 4 and cross member 5 to hold the floor 31 in place. Additionally, it is sometimes desirable to enclose the extended area of the cargo bed that is provided by the cargo bed extender as shown in FIGS. 5 and 24. The enclosure includes a right side sideboard or panel 21, a left side sideboard or panel 22 and a tailgate 23. These are placed in a vertical position at the end of the cargo bed extender and attached to the movable members and cross member to secure them in place. The side panels are further secured in place by a right front panel 24 that extends from the front end of the right side panel 21 to the side of the main cargo area of the cargo transport. Similarly a front panel on the left side 25 is provided to support the left side board 22 by attachment to the left side of the cargo transport. The right side panel 21 and left side panel 22 are attached to the movable members 3 and 4 by screws 27 that have an upstanding handle on the head that may be grasped to turn the screws 27. Similarly, the tailgate is attached to the cross member 5 by screws 27 and a rod 30 on the inside and at each end of the tailgate and short pieces of pipe 29 that receive a rod 30.

The cargo bed extender advantageously has members sized so that the movable members and cross members when inside the attached members fit in the cargo area with the tailgate closed. Additionally, the movable members and cross member may be separated from the attached members for storage or for placement in the cargo area.

Although the description above contains much specificity, this should not be construed as limiting the scope of the invention, but merely as providing illustrations of one of the presently preferred embodiments of the invention. Although preferred embodiments of the apparatus for extending the cargo bed of a cargo transport have been described above, the invention is not limited to these specific embodiments, but rather the scope of the invention is to be determined as claimed.

1. A device for extending the load carrying ability of a cargo transport beyond the end of a cargo bed comprising a first attached member in the cargo bed aligned from front to back in the bed, a second attached member lying parallel to the first attached member in the cargo bed, a first movable member inside the first attached member and able to telescope from the first attached member beyond the end of the cargo bed, a second movable member inside the second attached member and able to telescope from the second attached member beyond the end of the cargo bed, and a cross member attached at one end to the remote end of the first movable member and attached at the other end to the remote end of the second movable member.

2. An extending device in accordance with claim 1, further comprising a first safety latch between the first attached member and the first movable member and a second safety latch between the second attached member and the second movable member.

3. An extending device in accordance with claim 1, wherein each attached member is attached at the front end near the front of the cargo bed.

4. An extending device in accordance with claim 2, further comprising a lifting block under the rear end of each attached member.

5. An extending device in accordance with claim 1, further comprising a lifting block under the rear end of each attached member and a pin in each lifting block that cooperates with a hole in the bottom of the corresponding movable member to provide a safety latch.

6. An extending device in accordance with claim 5, further comprising a compression and locking arm positionable on top of the movable member in the vicinity of the pin in the lifting block.

7. An extending device in accordance with claim 6, wherein the safety latch locking arm has a first leg pivotably mounted along the side of the attached member, a spring mounted on the leg, a washer and a nut beyond the spring to hold the spring on the leg of the locking arm, and a second leg, the end of which fits in a hole in a mount on the side of the attached member.

8. An extending device in accordance with claim 2, wherein the movable members have holes along a longitudinal line and the safety latch on each side comprises an arm carrying a pin that is biased toward the movable member and fits in a hole in the movable member.

9. An extending device in accordance with claim 1, wherein the first and second attached members consist of schedule 10 steel pipe.

10. An extending device in accordance with claim 9, wherein the attached members have a length between 5 feet and 8 feet.

11. An extending device in accordance with claim 9, wherein the first and second movable members consist of schedule 40 steel pipe.

12. An extending device in accordance with claim 11, wherein the first and second movable members have a length between 5 feet and 8 feet.

13. An extending device in accordance with claim 11, wherein the cross member consists of schedule 40 steel pipe.

14. An extending device in accordance with claim 1, further comprising a heavy load support consisting of two telescoping arms attached at a common end to a coupler that fits in a trailer hitch receiver at the rear of the cargo transport.

15. An extending device in accordance with claim 14, wherein the heavy load support has two telescoping arms with two schedule 10 steel pipes adjacent the common end and the trailer hitch receiver and two schedule 40 steel pipes that telescope inside the schedule 10 steel pipes and extend to the cross member to support the rear end of the extending device when extended beyond the rear end of the cargo bed.

16. An extending device in accordance with claim 1, further comprising a safety latch comprising a spring loaded pin attached to the attached member and extending over a hole in the movable member wherein the pin may engage holes in the movable member with the spring loaded pin biased toward and into a hole in the movable member.

17. An extending device in accordance with claim 16, wherein the safety latch further comprises grips on each side of the pin so that the spring loaded pin may be pulled out of a hole in the movable member to release the movable member.

18. An extending device in accordance with claim 1, wherein the attached members and the movable members with cross member are separable for storage of the movable members and cross member.

19. An extending device in accordance with claim 1, wherein each attached member is detachably fixed to the cargo bed near the front end of the cargo bed.

20. An extending device in accordance with claim 1, wherein the cargo bed is a bed of a pickup truck with wheel wells inside the cargo bed, wherein each attached member lays inside the cargo bed next to a wheel well and extends from an area near the front of the bed to an area near the rear of the bed.

21. An extending device in accordance with claim 20, wherein the area near the front of the bed is within one foot of the front end of the cargo bed.

22. An extending device in accordance with claim 21, wherein the area near the rear of the bed is within one foot of the rear end of the cargo bed.

23. An extending device in accordance with claim 20, wherein the means for attaching the front end of each attached member is a securing plate that is bolted to the truck bed and the attached member is welded to the plate.

24. An extending device in accordance with claim 22, further comprising means for keeping the rear end of each attached member above the level of the truck bed.

25. An extending device in accordance with claim 24, wherein each movable member has holes at selected distances along a line at the bottom of each movable member and means for latching the movable member to its corresponding attached member consisting of a pin that engages a selected hole in the movable member.

26. An extending device in accordance with claim 25, wherein the securing means further includes a locking clamp that is attached to the attached member and lays on top of the corresponding movable member to hold the movable member down against the pin.

27. (canceled)

28. (canceled)

29. An extending device in accordance with claim 3, further comprising means for securing each telescoping member at a selected telescoped position.

30. An extending device in accordance with claim 29, further comprising means for elevating each attached member new the rear-end of the attached member above the level of the cargo bed.
